(19) United States
(12) Patent Application Publication
(10) Pub. No.: US 2026/0023362 A1
(43) Pub. Date: Jan. 22, 2026

(54) SCADA WEB HMI SYSTEM

(71) Applicant: TMEIC Corporation, Tokyo (JP)

(72) Inventors: Ryo SHIMIZU, Tokyo (JP); Akira NOJIMA, Tokyo (JP); Nobuo SHIMIZU, Tokyo (JP)

(73) Assignee: TMEIC Corporation, Tokyo (JP)

(21) Appl. No.: 18/995,165

(22) PCT Filed: Jul. 12, 2023
(86) PCT No.: PCT/JP2023/025781

§ 371 Date: Jan. 16, 2025

(51) Int. Cl. G05B 19/05

(52) U.S. Cl. CPC G05B 19/058; G05B 19/052; G05B 19/054; G05B 19/056; G05B 2219/23067; G05B 2219/23081; G05B 2219/23187; G05B 2219/24215

(57) ABSTRACT

A SCADA web HMI system includes a plurality of PLCs, a plurality of HMI client devices, and a SCADA serve device. The SCADA server device includes a communication driver and a client management unit connected to the plurality of HMI client devices. The client management unit transmits in-use screen information indicating a screen currently used by the HMI client devices to the communication driver. The communication driver acquires a screen-specific device list in which parts, and numbers and memory addresses of the PLCs storing the signal data corresponding to the parts are defined, for each of screens displayed on the HMI client devices, selects the signal data defined in the screen-specific device list corresponding to the currently-used screen indicated by the in-use screen information, adds a screen identifier to the selected signal data, and transmits the resultant signal data to the client management unit for each data type.

### TECHNICAL FIELD

The present invention relates to a SCADA web HMI system, and in particular to a technique for improving efficiency of signal processing in a large-scale SCADA web HMI system.

### BACKGROUND ART

SCADA (Supervisory Control And Data Acquisition) is known as a mechanism for supervising and controlling a social infrastructure system. The social infrastructure system includes a steel rolling system, a power transmission and transformation system, a water and sewage treatment system, a building management system, a road system, and the like. SCADA is a type of industrial control system, and performs system supervision, process control, and data collection by a computer. SCADA requires quick responsiveness (real-time property) corresponding to processing performance of the system.

SCADA includes, as sub-systems, an HMI (Human Machine Interface), a PLC (Programmable Logic Controller), and a communication base. The HMI is a mechanism that presents data on a supervisory object device to an operator, and enables the operator to supervise and control the supervisory object device. The PLC receives (collects) the data on the supervisory object device, and transmits control commands to the supervisory object device.

As an example of a SCADA HMI sub-system, PTL 1 discloses a system including HMI client devices and a server device. In an existing SCADA as disclosed in PTL 1, the server device transmits data (PLC signals such as input/output signals and alarm signals) received from the PLC to each of the HMI client devices. The input/output signals are signals relating to the supervisory object device (field devices configuring industrial plant), and include, for example, actuator control signals and sensor detection signals.

In a large-scale system, the HMI sub-system connects hundreds of thousands or more of signals to the PLC. In the existing server device that performs both of supervisory control and data collection, a high-performance processor and a large-capacity memory are necessary in order to process a large number of signals in real time, which increases cost.

To realize cost reduction of the SCADA HMI sub-system, the inventor of the present application has developed a browser-based SCADA HMI sub-system. This makes it possible to realize an HMI screen as a web application operating on a web browser. As one of advantages of realization of the HMI screen on the web browser, data can be easily acquired from different web servers by switching a URL (including port number).

### CITATION LIST

### Patent Literature

[PTL 1] JP 2017-27211 A

[PTL 2] JP H11-120104 A

### SUMMARY OF THE INVENTION

### Problems to be Solved by the Invention

In a large-scale SCADA web HMI system, it is anticipated that a large number of (for example, 128) HMI client devices are connected to one SCADA server device. For example, in a steel hot rolling plant, a large number of sensors and actuators are installed in a rolling line, and signal data including sensor detection signals and actuator control signals are transmitted to the PLC through a control network. The signals collected to the PLC are required to be transmitted to each of the HMI client devices in real time. Therefore, one SCADA server device is required to manage the large number of (for example, 128) HMI client devices by collecting functions of a communication driver and a client management unit to the SCADA server device. In addition, high-speed response, for example, display response within 200 msec and operation response within 500 msec is required. To meet such requirements, it is necessary to improve efficiency of signal processing in the SCADA server device.

The present disclosure is to solve the above-described issues. An object of the present disclosure is to provide a SCADA web HMI system that can improve efficiency of signal processing in a SCADA server device.

### Solution to Problem

A first aspect of the present disclosure relates to a SCADA web HMI system. The SCADA web HMI system comprises a plurality of programmable logic controllers (hereinafter, referred to as “PLCs”), a plurality of HMI (Human Machine Interface) client devices, and a SCADA server device that are connected through a computer network. Each of the PLCs is configured to include a plurality of memory addresses storing signal data relating to field devices configuring an industrial plant, and to periodically transmit block data including a set of the signal data to the computer network. Each of the HMI client devices is configured to execute a web browser displaying a plurality of screens each including a plurality of arranged parts. The SCADA server device includes a communication driver and a client management unit connected to the plurality of HMI client devices. The communication driver is configured to receive the block data transmitted from the PLCs, to divide the block data into signal data of respective data types, to add a signal identifier to the divided signal data, and to transmit the signal data to the client management unit for each data type. The client management unit is configured to receive the signal data transmitted from the communication driver, and to transmit the received signal data to the HMI client device corresponding to the signal identifier. The client management unit is configured to acquire in-use screen information indicating the screen currently used in the HMI client devices, and to transmit the acquired screen information to the communication driver. The communication driver is configured to acquire a screen-specific device list in which the parts, and numbers and the memory addresses of the PLCs storing the signal data corresponding to the parts are defined, for each of the screens displayed on the HMI client devices, to select the signal data defined in the screen-specific device list corresponding to the currently-used screen indicated by the in-use screen information, to add a screen identifier to the selected signal data, and to transmit the resultant signal data to the client management unit for each data type.

It is necessary to associate the parts displayed on the screen with the PLC signals corresponding to the parts on a one-to-one basis. Therefore, a second aspect further includes the following characteristics in addition to the first aspect. The communication driver is configured to acquire a screen reference device list in which the parts and a screen of a reference source of the parts are defined, for each of the screens displayed on the HMI client devices, to further add the screen identifier to the signal data on the parts defined in the screen reference device list corresponding to the currently-used screen indicated by the in-use screen information, and to transmit the resultant signal data to the client management unit for each data type.

A third aspect further includes the following characteristics in addition to the second aspect. The SCADA web HMI system further comprises a screen designing device connected to the computer network and including an engineer tool for designing the screens. The screen designing device is configured to design the screens and to create the screen-specific device list and the screen reference device list corresponding to each of the designed screens.

A fourth aspect further includes the following characteristics in addition to any one of the first to third aspects. The communication driver, communication driver is configured to acquire a screen common device list in which warning information to be displayed on the screens and the number and the memory address of the PLC storing the signal data corresponding to the warning information are defined, irrespective of a type of the screen displayed on the HMI client devices, and to transmit, in a case where a value of the signal data defined in the screen common device list is updated, the updated signal data to the client management unit.

### Advantageous Effects of the Invention

According to the first aspect of the present disclosure, the communication driver selects the signal data relating to the screen currently used by any of the HMI client devices, and only the selected signal data is transmitted from the communication driver to the client management unit. In other words, the communication driver filters the signal data on the screen not currently used by the HMI client devices, by using the in-use screen information and the screen-specific device list. This makes it possible to improve efficiency of the signal processing in the SCADA server device. As a result, it is possible to improve efficiency of the signal processing in the SCADA web HMI system.

According to the second aspect, even in a case where none of the HMI client devices displays a screen of a reference source, only the signal data on the referred parts can be transmitted from the communication driver to the client management unit by using the screen reference device list. In this case, among the signal data on the screen of the reference source, signal data other than the referred parts are not transmitted from the communication driver to the client management unit. This makes it possible to further improve efficiency of the signal processing in the SCADA server device.

According to the third aspect, the communication driver can acquire the screen-specific device list and the screen reference device list created by the screen designing device.

According to the fourth aspect, even when any screen is displayed on the HMI client devices, the warning information can be displayed by using the screen common device list. It is unnecessary to create the screen common device list for each of the screens. Therefore, management is easy as compared with a case where the warning information is defined in each screen-specific device list.

### BRIEF DESCRIPTION OF DRAWINGS

FIG. 1 is a diagram to explain a configuration example of a SCADA web HMI system according to Embodiment 1.

FIG. 2 is a schematic view to explain a screen-specific device list corresponding to each of HMI screens.

FIG. 3 is a schematic view to explain operation of a SCADA server device according to Embodiment 1.

FIG. 4 is a schematic view to explain signal processing in the SCADA server device.

FIG. 5 is a schematic view to explain update flags.

FIG. 6 is a schematic view to explain a screen common device list.

FIG. 7 is a schematic view to explain a screen-specific device list corresponding to the HMI screen.

FIG. 8 is a schematic view to explain operation of the SCADA server device according to Embodiment 2.

FIG. 9 is a block diagram illustrating a hardware configuration example of the SCADA server device and a HMI client device.

### DESCRIPTION OF EMBODIMENTS

Some embodiments of the present disclosure are described in detail below with reference to drawings. Note that elements common to the drawings are denoted by the same reference numerals, and repetitive description is omitted.

### Embodiment 1

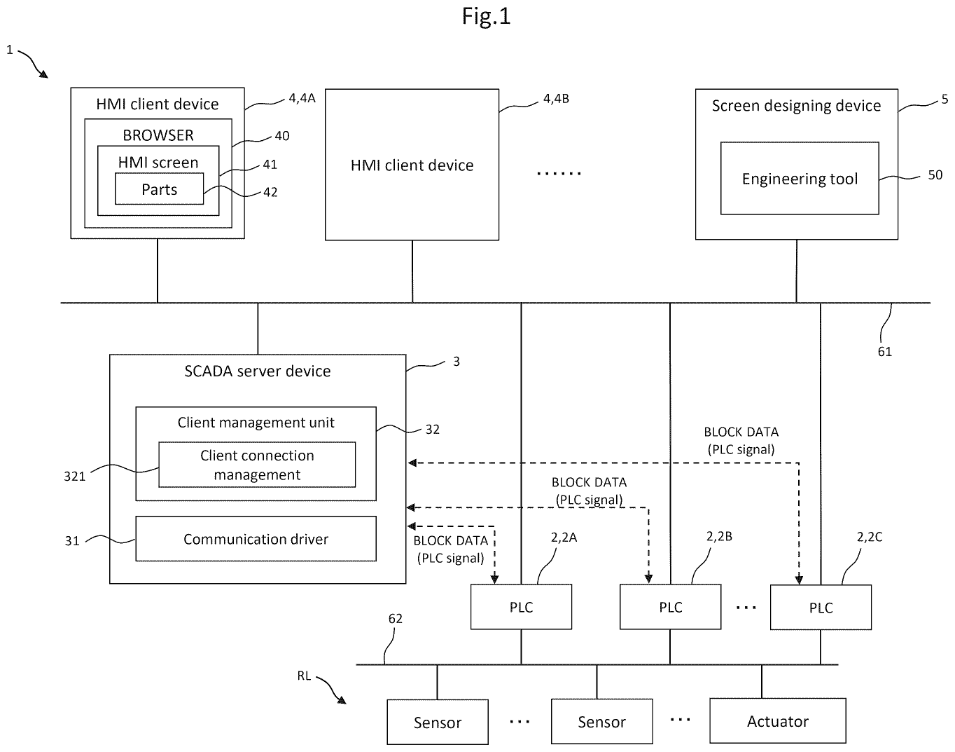

FIG. 1 is a diagram to explain a configuration example of a SCADA web HMI system 1 according to Embodiment 1.

The SCADA web HMI system 1 includes a plurality of PLCs 2, a SCADA server device (hereinafter, also referred to as “server”) 3, a plurality of HMI client devices (hereinafter, also referred to as “clients”) 4, and a screen designing device 5. The PLCs 2, the server 3, the clients 4, and the screen designing device 5 are connected to one another through a computer network 61. The computer network 61 is, for example, Ethernet (R).

The PLCs 2 are connected to field devices configuring an industrial plant through a control network 62. The industrial plant is, for example, a steel rolling plant including a rolling line RL. A plurality of sensors and actuators as the field devices are installed in the rolling line RL. The sensors and the actuators are connected to the PLCs 2 through the network 62. Each of the PLCs 2 internally includes an address table, and memory addresses storing signal data (hereinafter, also referred to as “PLC signal”) relating to the plurality of sensors and actuators are defined in the address table. Each of the PLCs 2 periodically transmits a packet (PACKET) including block data (BLOCK DATA) that is a set of a plurality of PLC signals, to the computer network 61 by multicast or broadcast. A transmission period is set, for example, within a range from several msec to several hundred msec. One piece of block data includes several tens of to several hundred PLC signals. The PLC signals include input/output signals (including actuator control signals and sensor detection signals) and alarm signals. The block data includes at least one of a set of input/output signals and a set of alarm signals. The block data is periodically transmitted to the server 3 irrespective of whether values of the PLC signals are changed from previous values.

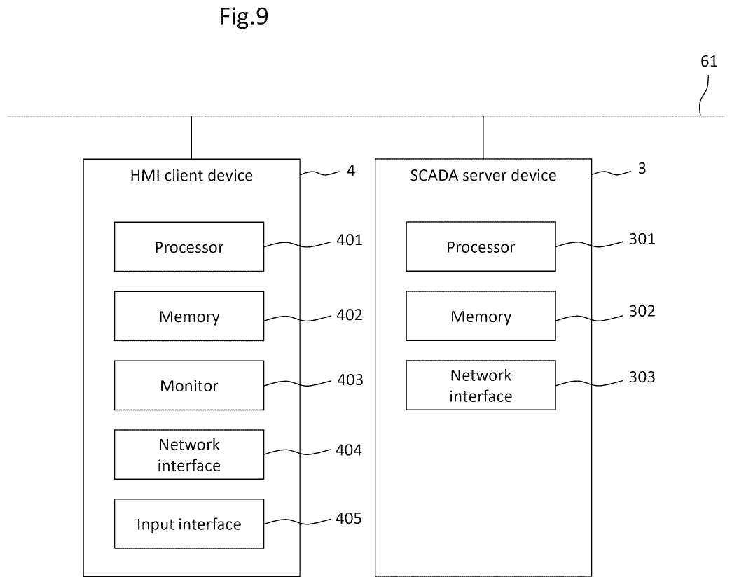

The server 3 includes a communication driver 31 and a client management unit 32 connected to the plurality of clients 4. The server 3 includes a processor 301, a memory 302, and a network interface 303 illustrated in FIG. 9 described below. The processor 301 is configured to perform various kinds of processing and various kinds of functions of the server 3 by executing programs stored in the memory 302.

The communication driver 31 performs reception processing for periodically receiving the block data from the PLCs 2, and unpack processing for decomposing the received block data into a plurality of PLC signals for each data type. Examples of the data types of the PLC signals include “BIT (data size 1 bit)”, “SHORT (data size 2 byte)”, and “FLOAT (data size 4 byte)”; however, the other data types can be used. The communication driver 31 further performs packet processing (transmission processing) for generating packet (PACKET) for each data type by adding a corresponding signal identifier to each of the PLC signals, and transmitting the generated packet to the client management unit 32. In other words, data transmitted from the communication driver 31 to the client management unit 32 includes a pair of the signal identifier and a value of the PLC signal.

The signal identifier corresponds to a character string described by an application designer, and is a binary ID unique to each data type. A data size of the signal identifier is, for example, 23 bits. Accordingly, the signal identifier can represent about eight million PLC signals for each data type, and can sufficiently support the large-scale SCADA web HMI system 1. In a case of BIT-type data, the size of the signal identifier is 23 bits, and the size of the value of the PLC signal (data) is 1 bit. Therefore, the data size per one signal is 24 bits (=3 bytes). In a case of float-type data, the size of the signal identifier is 23 bits, and the size of the value of the data is 4 bytes. Therefore, the data size per one signal including 1 bit of padding is 7 bytes.

The client management unit 32 receives the packets (PLC signals for respective data types) from the communication driver 31, stores the PLC signals for respective data types by using the signal identifiers as indexes, sorts the stored PLC signals for each of HMI screens 41, adds screen identifiers corresponding to the signal identifiers to the PLC signals (packets) with reference to a conversion table CT2 described below, and transmits the resultant PLC signals to the clients 4.

Each of the clients 4 includes a processor 401, a memory 402, and a monitor 403 illustrated in FIG. 9 described below. The processor 401 is configured to execute a web browser 40 displaying the HMI screens 41 in which display parts (hereinafter, referred to as “parts”) 42 are arranged, by executing programs stored in the memory 402. The parts 42 are also referred to as “items”. The monitor 403 displays the HMI screens 41 of the web browser 40.

The web browser 40 can acquire various kinds of information on HTML documents relating to the HMI screens 41, from a web server (not illustrated) specified by a URL. The web server is constructed in the server 3. The HMI screens 41 include a supervisory screen required to have real-time property.

In a case where the HMI screen 41 currently used is the supervisory screen, the web browser 40 changes display states of the parts 42 based on the PLC signals transmitted from the server 3, namely, the PLC signals from the sensors and the actuators. Change in the display states indicates, for example, change in a numerical value, characters, a color, or a shape. The parts 42 are dynamically displayed based on the change of the PLC signals. Therefore, the parts 42 and the PLC signals are associated with each other.

All of the PLC signals decomposed by the communication driver 31 are generally transmitted to the client management unit 32, but this may increase a processing load on the client management unit 32. The PLC signals transmitted to the client management unit 32 include PLC signals of the parts 42 of the HMI screen 41 not used (displayed) by any of the clients 4, and it is unnecessary to transmit such PLC signals to the client management unit 32.

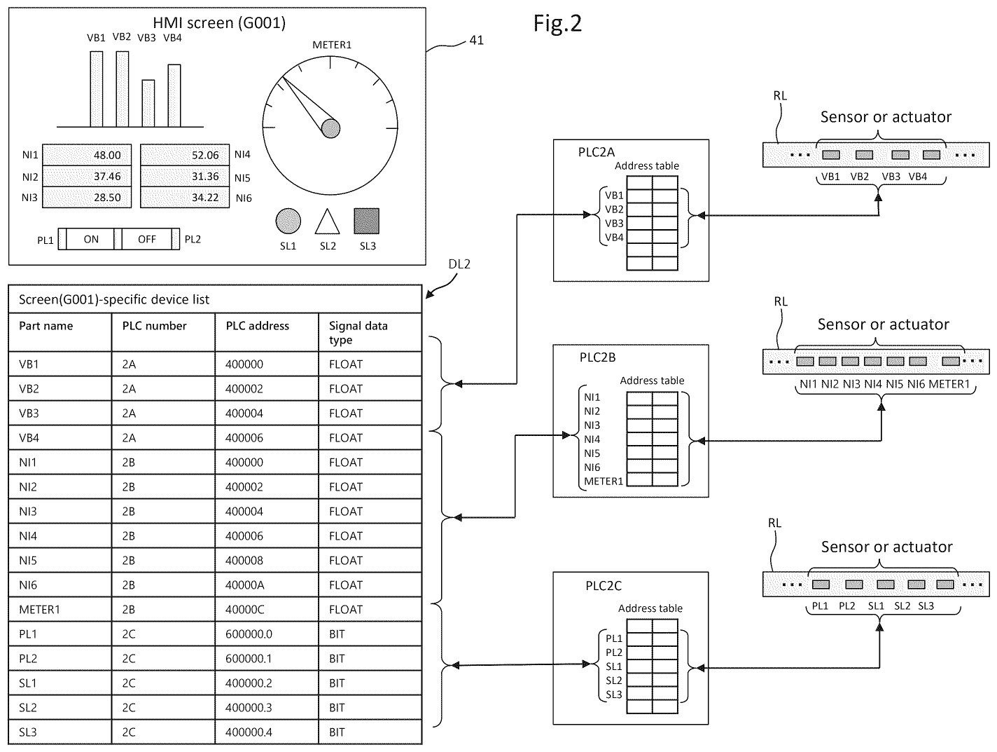

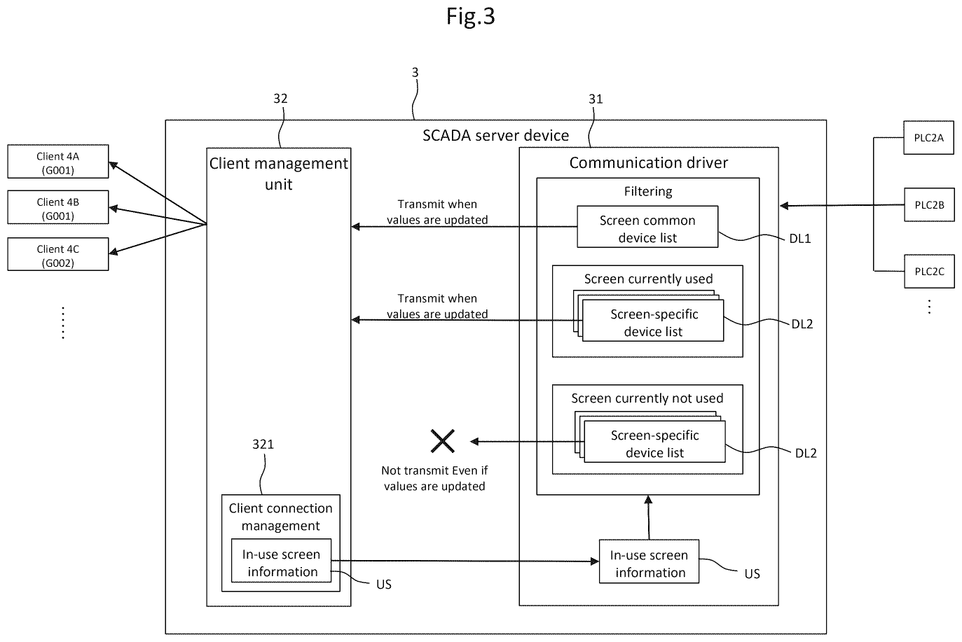

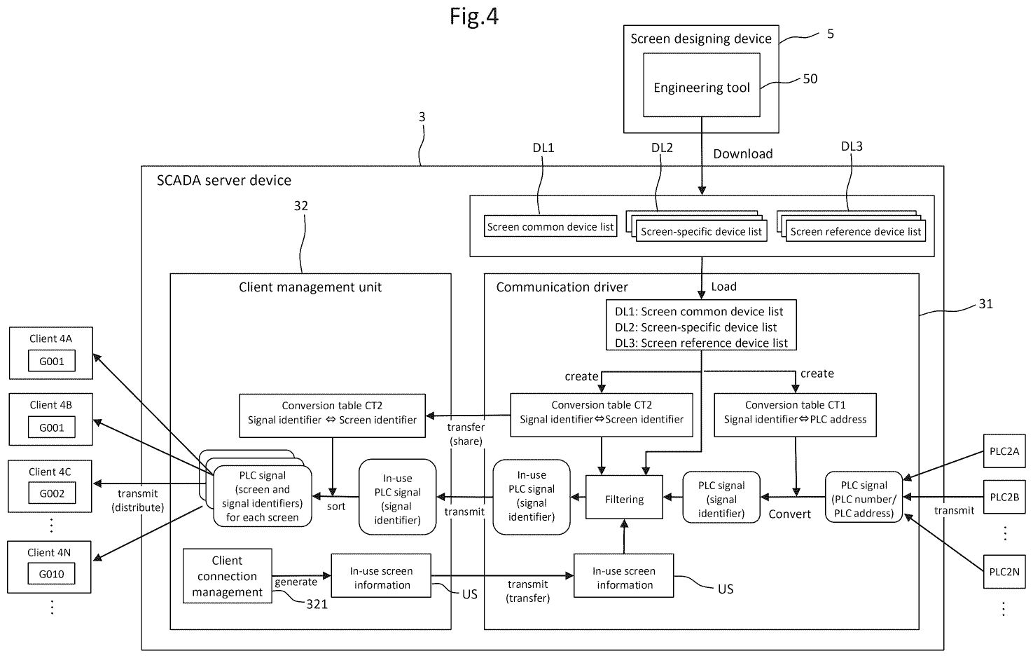

Therefore, in the present embodiment, the communication driver 31 has a filtering function. The filtering function of the communication driver 31 is described with reference to FIG. 2 to FIG. 4. FIG. 2 is a schematic view to explain a screen-specific device list corresponding to each of the HMI screens. FIG. 3 is a schematic view to explain operation of the server 3 according to Embodiment 1. FIG. 4 is a schematic view to explain signal processing in the server 3.

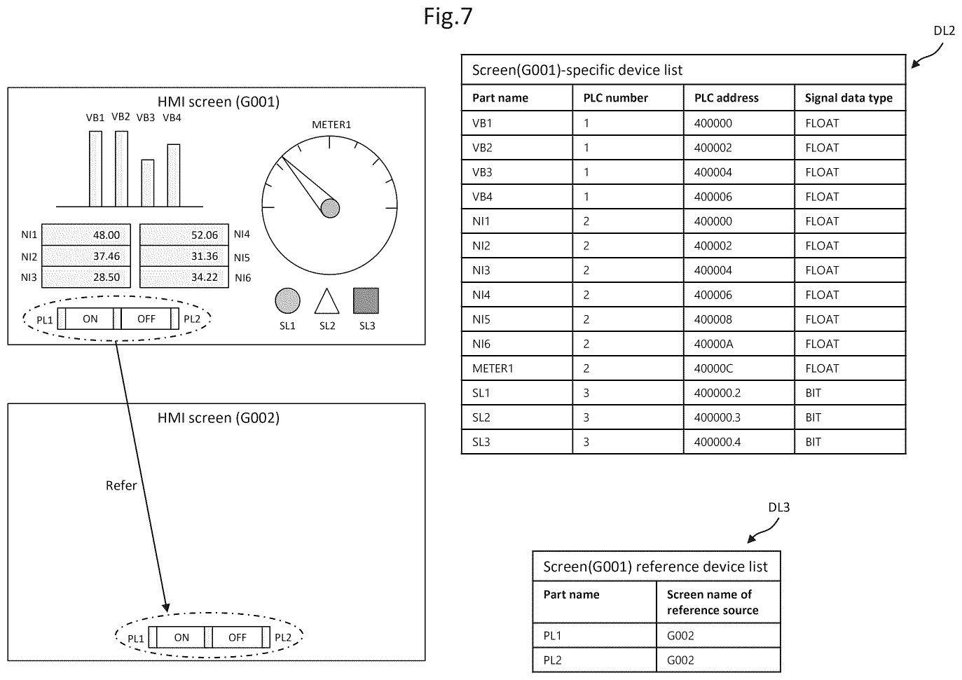

The communication driver 31 acquires a screen-specific device list DL2 in which a plurality of parts, numbers and memory addresses of the PLCs 2 storing the PLC signals corresponding to the respective parts, and signal data types are defined, for each of the HMI screens 41 displayed on the clients 4. The screen-specific device list DL2 can be downloaded and acquired from the screen designing device 5. The screen designing device 5 includes an engineering tool 50. When each of the HMI screens 41 is designed by the engineering tool 50, the screen designing device 5 creates the screen-specific device list DL2, a screen common device list L1 illustrated in FIG. 7 described below, and a screen reference device list L3 described in Embodiment 2 described below.

The communication driver 31 creates a conversion table CT1 between the PLC address and the signal identifier, and the conversion table CT2 between the screen identifier and the signal identifier, from the various kinds of device lists L1 to L3. The created conversion table CT2 between the screen identifier and the signal identifier is transferred to the client management unit 32 and is shared. The screen identifier is a unique identifier indicating the displayed HMI screen 41.

Each of the PLCs 2 includes an address book, and the PLC signals corresponding to the respective parts are stored in memory addresses defined in the address book. A plurality of parts are arranged in the HMI screen (G001) 41 illustrated in FIG. 2. Parts VB1 to VB4 are bar graphs each changed in height based on a value of the corresponding PLC signal of a PLC 2A. Parts NI1 to NI6 each have a value varied based on a value of the corresponding PLC signal of a PLC 2B, and a part METER1 is a meter changed in position of a needle based on a value of the corresponding PLC signal of a PLC 2B. Parts PL1 and PL2 are operation buttons transmitting instructions to the actuators based on the corresponding PLC signals of a PLC 2C. The parts PL1 and PL2 are operated by an operator on the HMI screen 41. Parts SL1 to SL3 are animation parts each changed in color based on the corresponding PLC signal of the PLC 2C. The parts SL1 to SL3 are configured such that the colors are changed when the parts PL1 and PL2 are in predetermined states.

In the screen-specific device list DL2, for example, a part number “VB1”, a PLC number “2A” and a memory address “400000” in the PLC 2A where the PLC signal corresponding to the part VB1 is stored, and a data type “FLOAT” of the PLC signal are defined.

The client management unit 32 has a client connection management function 321. The client connection management function 321 generates in-use screen information US. The in-use screen information US is information on the HMI screen 41 currently used (displayed) by any of the clients 4. The generated in-use screen information US is transmitted to the communication driver 31. As a result, the communication driver 31 can use the in-use screen information US for the filtering function.

The communication driver 31 filters the PLC signals by using the in-use screen information US and the screen-specific device list DL2. In other words, the communication driver 31 does not transmit the PLC signals defined in the screen-specific device list DL2 of the HMI screen 41 not currently used (displayed), to the client management unit 32. In contrast, the communication driver 31 adds the identifiers to the PLC signals defined in the screen-specific device list DL2 of the HMI screen 41 currently used (displayed), and transmits the resultant PLC signals to the client management unit 32.

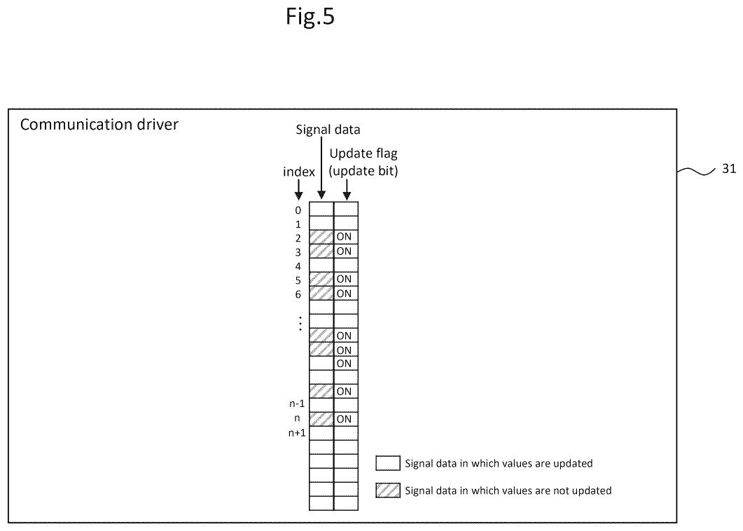

At this time, all of the PLC signals defined in the screen-specific device list DL2 may be transmitted; however, only the PLC signals having the updated values are preferably transmitted. In this case, as illustrated in FIG. 5, the communication driver 31 can be configured so as to have update bits that are turned ON when the values of the PLC signals are updated (turned OFF when values of PLC signals are not updated). FIG. 5 is a schematic view to explain update flags. Each of the update bits is the update flag of 1 bit. The communication driver 31 can transmit, among the PLC signals defined in the screen-specific device list DL2, the PLC signals in which the update bits are ON, to the client management unit 32.

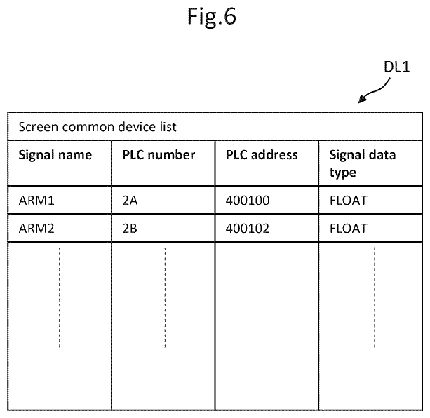

Further, to notify the operator of warning information indicating change in value of a specific PLC signal, a dialog box of the warning information is required to be displayed on the HMI screen 41 irrespective of a type of the displayed HMI screen 41. To meet the requirement, the screen common device list DL1 is used. FIG. 6 is a schematic view to explain the screen common device list DL1. The screen common device list DL1 illustrated in FIG. 6 has a format similar to the format of the above-described screen-specific device list DL2. In the screen common device list DL1, for example, a signal name “ARM1”, a PLC number “PLC2A” and a memory address “400100” in the PLC 2A where the PLC signal corresponding to the signal name

“ARM1” is stored, and a data type “FLOAT” of the PLC signal are defined. When the value of the PLC signal corresponding to the signal name “ARM1” is updated, the communication driver 31 transmits the PLC signal having the updated value, to the client management unit 32. This makes it possible to display the dialog box of the warning information on the HMI screen 41 irrespective of the displayed HMI screen 41, and to notify the operator of the update. Note that it can be determined whether the value has been updated, based on the above-described update bit.

As described above, according to the present embodiment, all of the PLC signals received by the communication driver 31 are not transmitted to the client management unit 32, but only the PLC signals for the HMI screen 41 currently used by any of the clients 4 are selected and only the selected PLC signals are transmitted from the communication driver 31 to the client management unit 32. In other words, the communication driver 31 filters the PLC signals for the HMI screen 41 not displayed on the clients 4 by using the in-use screen information and the screen-specific device list DL2. This makes it possible to improve efficiency of the signal processing in the server 3. As a result, it is possible to improve efficiency of the signal processing in the SCADA web HMI system 1.

### Embodiment 2

Next, Embodiment 2 of the present disclosure is described. In the present embodiment, differences from Embodiment 1 described above are mainly described. As described above in Embodiment 1, it is necessary to associate the parts 42 displayed on the HMI screen 41 with the PLC signals of the parts 42 on a one-to-one basis. Therefore, for example, the parts disposed in the HMI screen (G001) 41 are referred to by another HMI screen (G002) 41 in some cases.

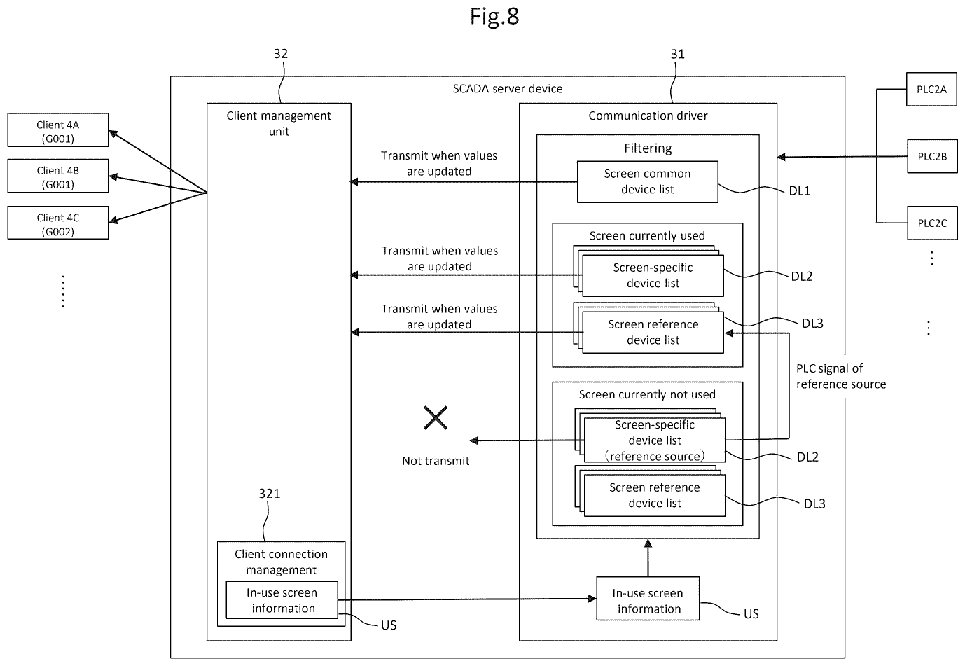

FIG. 7 is a schematic view to explain the screen reference device list DL3 corresponding to the HMI screen 41. FIG. 8 is a schematic view to explain operation of the server 3 according to Embodiment 2.

Two parts “PL1, PL2” disposed in the HMI screen (G001) 41 illustrated in FIG. 7 refer to parts “PL1, PL2” in the other HMI screen (G002). In this case, the parts “PL1, PL2” are defined not in the screen-specific device list DL2 of the HMI screen (G001) but in the unillustrated screen-specific device list DL2 of the HMI screen (G002). The parts “PL1, PL2” are defined in the screen reference device list DL3 of the HMI screen (G001). In the screen reference device list DL3, for example, a part name “PL1” and a screen name “G002” of a reference source are defined.

The communication driver 31 filters the PLC signals by using the in-use screen information US, the screen-specific device list DL2, and the screen reference device list DL3. As in Embodiment 1 described above, the communication driver 31 does not transmit the PLC signals defined in the screen-specific device list DL2 of the HMI screen 41 not currently used (displayed), to the client management unit 32. In contrast, the communication driver 31 transmits the PLC signals defined in the screen-specific device list DL2 of the HMI screen 41 currently used (displayed), to the client management unit 32. Further, in the present embodiment, the communication driver 31 transmits the PLC signals of the reference source defined in the screen reference device list DL3 of the HMI screen 41, to the client management unit 32. At this time, as in Embodiment 1 described above, all of the PLC signals defined in the screen-specific device list DL2 and the screen reference device list DL3 may be transmitted; however, only the PLC signals having the updated values are preferably transmitted.

As described above, according to the present embodiment, all of the PLC signals received by the communication driver 31 are not transmitted to the client management unit 32, but the PLC signals of the HMI screen 41 currently displayed on any of the clients 4 and the PLC signals of the parts 42 referred to by the HMI screen 41 currently used are selected, and only the selected PLC signals are transmitted from the communication driver 31 to the client management unit 32. In other words, the communication driver 31 filters the PLC signals for the HMI screen 41 not displayed on the clients 4 by using the in-use screen information, the screen-specific device list DL2, and the screen reference device list DL3. This makes it possible to improve efficiency of the signal processing in the server 3. As a result, it is possible to improve efficiency of the signal processing in the SCADA web HMI system 1. Moreover, among the PLC signals for the HMI screen 41 as the reference source, the PLC signals other than the referred parts 42 are not transmitted from the communication driver to the client management unit. This makes it possible to further improve efficiency of the signal processing in the SCADA server device.

FIG. 9 is a block diagram illustrating a hardware configuration example of the server 3 and each of the clients 4. The above-described processing of the server 3 is realized by a processing circuit. The processing circuit includes the processor 301, the memory 302, and the network interface 303 that are connected to one another. The processor 301 realizes the filtering function and the other functions of the server 3 by executing various kinds of programs stored in the memory 302. The memory 302 includes a main storage device and an auxiliary storage device. The memory 302 further includes a storage area temporarily storing the PLC signals.

The above-described processing of each of the clients 4 is realized by a processing circuit. The processing circuit includes the processor 401, the memory 402, at least one monitor 403, a network interface 404, and an input interface 405 that are connected to one another. The processor 401 realizes the functions of the own client 4 by executing various kinds of programs stored in the memory 402. The memory 402 includes a main storage device and an auxiliary storage device. A plurality of monitors 403 may be provided. The input interface 405 includes input devices such as a keyboard, a mouse, and a touch panel. The operator can operate, for example, the parts “PL1, PL2” on the HMI screen (G001) 41 illustrated in FIG. 2 by using the input interface 405.

Although the embodiments of the present invention are described above, the present invention is not limited to the above-described embodiments, and can be variously modified and implemented without departing from the spirit of the present invention. In the above-described embodiments, the various kinds of device lists DL1 to DL3 are acquired from the screen designing device 5, but may be acquired from an external device.

When numerals of the number, the quantity, the amount, the range, and the like of each of the elements are mentioned in the above-described embodiments, the present invention is not limited to the mentioned numerals except for the case of being particularly clearly mentioned and the case of being obviously specified to the numerals in principle. Further, the structures and the like described in the above-described embodiments are not necessarily essential for the present invention except for the case of being particularly clearly mentioned and the case of being obviously specified to the structure and the like in principle.

### REFERENCE SIGNS LIST

1 . . . SCADA web HMI system, 2 . . . Programmable Logic Controller (PLC), 3 . . . SCADA server device, 31 . . . communication driver, 32 . . . client management unit, 4 . . . HMI client device, 40 . . . web browser, 41 . . . HMI screen (screen), 42,VB1 to VB4,NI1 to NI6,METER1,PL1,PL2,SL1 to SL3 . . . parts, display parts, DL1 . . . screen common device list, DL2 . . . screen-specific device list, DL3 . . . screen reference device list

1. A SCADA (Supervisory Control And Data Acquisition) web HMI system comprising a plurality of programmable logic controllers (hereinafter, referred to as “PLCs”), a plurality of HMI (Human Machine Interface) client devices, and a SCADA server device that are connected through a computer network, wherein
each of the PLCs is configured to include a plurality of memory addresses storing signal data relating to field devices configuring an industrial plant, and to periodically transmit block data including a set of the signal data to the computer network,
each of the HMI client devices is configured to execute a web browser displaying a plurality of screens each including a plurality of arranged parts,
the SCADA server device includes a communication driver and a client management circuitry connected to the plurality of HMI client devices,
the communication driver is configured to receive the block data transmitted from the PLCs, to divide the block data into signal data of respective data types, to add a signal identifier to the divided signal data, and to transmit the signal data to the client management circuitry for each data type,
the client management circuitry is configured to receive the signal data transmitted from the communication driver, and to transmit the received signal data to the HMI client device corresponding to the signal identifier,
the client management circuitry is configured to acquire in-use screen information indicating the screen currently used in the HMI client devices, and to transmit the acquired screen information to the communication driver, and
the communication driver is configured to acquire a screen-specific device list in which the parts, and numbers and the memory addresses of the PLCs storing the signal data corresponding to the parts are defined, for each of the screens displayed on the HMI client devices, to select the signal data defined in the screen-specific device list corresponding to the currently-used screen indicated by the in-use screen information, to add a screen identifier to the selected signal data, and to transmit the resultant signal data to the client management circuitry for each data type.

2. The SCADA web HMI system according to claim 1, wherein the communication driver is configured to acquire a screen reference device list in which the parts and a screen of a reference source of the parts are defined, for each of the screens displayed on the HMI client devices, to further add the screen identifier to the signal data on the parts defined in the screen reference device list corresponding to the currently-used screen indicated by the in-use screen information, and to transmit the resultant signal data to the client management circuitry for each data type.

3. The SCADA web HMI system according to claim 2, further comprising a screen designing device connected to the computer network and including an engineer tool for designing the screens, the screen designing device being configured to design the screens and to create the screen-specific device list and the screen reference device list corresponding to each of the designed screens.

4. The SCADA web HMI system according to claim 1, wherein the communication driver is configured to acquire a screen common device list in which warning information to be displayed on the screens and the number and the memory address of the PLC storing the signal data corresponding to the warning information are defined, irrespective of a type of the screen displayed on the HMI client devices, and to transmit, in a case where a value of the signal data defined in the screen common device list is updated, the updated signal data to the client management circuitry.

5. The SCADA web HMI system according to claim 2, wherein the communication driver is configured to acquire a screen common device list in which warning information to be displayed on the screens and the number and the memory address of the PLC storing the signal data corresponding to the warning information are defined, irrespective of a type of the screen displayed on the HMI client devices, and to transmit, in a case where a value of the signal data defined in the screen common device list is updated, the updated signal data to the client management circuitry.

6. The SCADA web HMI system according to claim 3, wherein the communication driver is configured to acquire a screen common device list in which warning information to be displayed on the screens and the number and the memory address of the PLC storing the signal data corresponding to the warning information are defined, irrespective of a type of the screen displayed on the HMI client devices, and to transmit, in a case where a value of the signal data defined in the screen common device list is updated. the updated signal data to the client management circuitry.
